(19) United States
(12) Patent Application Publication
(10) Pub. No.: US 2026/0365320 A1
(43) Pub. Date: Nov. 19, 2026

(54) AIRCRAFT HYDROGEN TANK SYSTEM COMPRISING A JET PUMP

(71) Applicant: Airbus Operations SAS, TOULOUSE (FR)

(72) Inventor: Mathieu BELLEVILLE, TOULOUSE (FR)

(21) Appl. No.: 19/675,951

(22) Filed: May 13, 2026

(30) Foreign Application Priority Data
May 15, 2025 (FR) FR2505185

(51) Int. Cl. B64D 37/28; B64D 37/00; B64D 37/30; F04D 13/12; F04D 27/00; F04F 5/02; F17C 7/02; G05D 7/06

(52) U.S. Cl. CPC B64D 37/28; B64D 37/005; B64D 37/30; F04D 13/12; F04D 27/001; F04F 5/02; F17C 7/02; G05D 7/0635; F17C 2205/0326; F17C 2205/0352; F17C 2221/012; F17C 2227/0142; F17C 2250/043; F17C 2250/0439; F17C 2250/0626; F17C 2265/066

(57) ABSTRACT

An aircraft tank system with a hydrogen tank, a first feed line submerged in the tank, a second feed line, a third feed line fluidically connected to a consumer system of the aircraft, a centrifugal pump mounted between the second feed line and the third feed line, a return line mounted between the third feed line and a high-pressure inlet of a jet pump further having a low-pressure inlet connected to the first feed line and an outlet connected to the second feed line.

### CROSS-REFERENCES TO RELATED APPLICATIONS

This application claims the benefit of French Patent Application Number FR 2505185, filed on May 15, 2025, the entire disclosure of which is incorporated herein by way of reference.

### FIELD OF THE INVENTION

The present invention relates to a hydrogen tank system for an aircraft, the tank system comprising a tank and a jet pump, and to an aircraft comprising such a tank system.

### BACKGROUND OF THE INVENTION

In an aircraft, it is known to install hydrogen tanks where the hydrogen is used in a consumer system as fuel in an engine such as a turbojet or turboprop. The hydrogen is thus stored in a tank where it generally takes the form of a liquid at a moderate pressure of 1 to 5 bar. In order to be optimally consumed by the consumer system, it is desirable for the hydrogen to be in gaseous form at a high pressure of 30 to 70 bar and at a temperature of 200 to 400 K.

The hydrogen is compressed by means of centrifugal pumps that are characterized by an operating range in respect of flow coefficient, i.e., the ratio between volume flow rate output and rotational speed. When the flow coefficient is too low, operation of the pump may become unstable, and when the flow coefficient is too high, it leads to a low efficiency, to excessive heating of the hydrogen and to loss of the ability to pressurize it.

It is known to artificially increase the flow rate through the pump by adding hydrogen at the pump inlet, but this extra hydrogen with respect to the requirements of the consumer system must then be diverted at the pump outlet. It may then be exhausted to the exterior, at the cost of substantial waste, or reinjected at the inlet of the pump, where heating of the flow entering the pump may compromise the suction capacity of the pump by decreasing the available net positive suction pressure (NPSP), or returned to the tank, this heating the hydrogen in the tank.

It would therefore be desirable to find an arrangement that would make more judicious use of the hydrogen diverted at the outlet of the centrifugal pump.

### SUMMARY OF THE INVENTION

One object of the present invention is to provide a tank system that does not have the problems of the prior art and that in particular makes optimum use of the hydrogen diverted at the outlet of the centrifugal pump.

To this end, a tank system for an aircraft is provided, said tank system comprising:
a tank intended to contain hydrogen,
a first feed line having a first end submerged in the tank and a second end,
a second feed line having a first end and a second end,
a third feed line having a first end and a second end that is intended to be fluidically connected to a consumer system of the aircraft,
a centrifugal pump mounted between the second end of the second feed line and the first end of the third feed line,
a return line having a first end fluidically connected to the third feed line and a second end, and
a jet pump having a low-pressure inlet fluidically connected to the second end of the first feed line, a high-pressure inlet fluidically connected to the second end of the return line and an outlet fluidically connected to the first end of the second feed line,
a control unit, and
a regulating means mounted on the return line, the regulating means being a regulating valve of adjustable cross section of flow controlled by the control unit,
wherein the control unit controls the regulating valve of adjustable cross section of flow so as to keep the net positive suction pressure (NPSP) at the inlet of the centrifugal pump within a range of values appropriate for the operation of the centrifugal pump.

With such a system, the energy contained in the hydrogen flowing through the return line makes the jet pump operate.

Advantageously, the jet pump is in the tank.

Advantageously, the tank system comprises a temperature sensor and pressure sensor placed at the second end of the second feed line and the control unit calculates the NPSP at the inlet of the centrifugal pump from measurements of temperature and pressure at the inlet of the centrifugal pump, said measurements being taken by said temperature sensor and said pressure sensor.

The invention also provides an aircraft comprising a consumer system and a tank system according to any of the preceding variants, the second end of the third feed line being fluidically connected to the consumer system.

### BRIEF DESCRIPTION OF THE DRAWINGS

The features of the invention that were mentioned above, and others, will become more clearly apparent on reading the following description of one example of embodiment, said description being given with reference to the appended drawings, in which:

FIG. 1 is a side view of an aircraft according to the invention,

FIG. 2 is a schematic representation of a tank system according to the invention,

FIG. 3 is a schematic representation of a jet pump implemented in the tank system according to the invention, and

FIG. 4 is a schematic representation of one example of a hardware architecture of a control unit of the tank system.

### DETAILED DESCRIPTION OF THE PREFERRED EMBODIMENTS

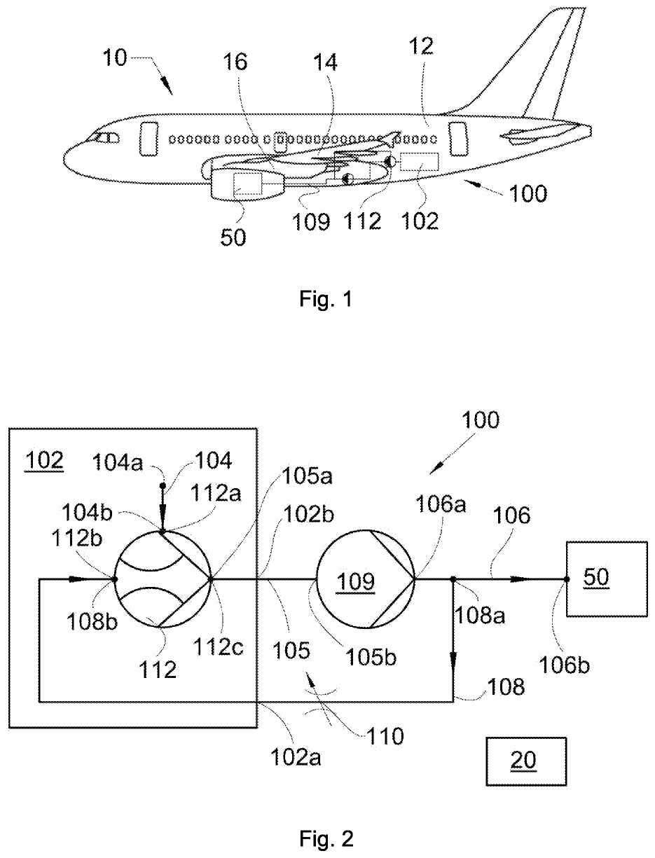

FIG. 1 shows an aircraft 10 comprising a tank system 100 according to the invention. The aircraft 10 here comprises, on either side of a fuselage 12, a wing 14 to which a pylon 16 bearing an engine 50 is fastened.

The tank system 100 comprises a tank 102 that here is housed in the fuselage 12 but that could also be housed in a wing 14 for example.

FIG. 2 shows the tank system 100 according to the invention with the tank 102, which contains hydrogen in liquid form. The tank 102 is conventionally an enclosure that is closed and seal-tight to hydrogen.

The tank 102 has an inlet orifice 102a and an outlet orifice 102b.

The tank system 100 comprises a first feed line 104 having a first end 104a that is submerged in the tank 102 in order to collect hydrogen therefrom and a second end 104b.

The tank system 100 comprises a second feed line 105 having a first end 105a and a second end 105b, and, lastly, the tank system 100 comprises a third feed line 106 having a first end 106a and a second end 106b that is fluidically connected to the consumer system (i.e. engine 50) of the aircraft 10 which operates through consumption of hydrogen. In the embodiment of the invention presented here, the consumer system 50 is the engine of the aircraft 10 and the second end 106b of the third feed line 106 thus opens into a combustion chamber of the engine 50 with a view to making it operate. In another embodiment of the invention, the consumer system 50 may be a fuel-cell stack that is supplied with hydrogen and oxygen with a view to generating electrical power used by the aircraft 10.

The tank system 100 also comprises a return line 108 that has a first end 108a which is fluidically connected to the third feed line 106 and a second end 108b.

To ensure movement of hydrogen from the tank 102 to the consumer system 50, the tank system 100 comprises a centrifugal pump 109 that is mounted between the second end 105b of the second feed line 105 and the first end 106a of the third feed line 106. The first end 108a of the return line 108 is thus between the consumer system 50 and the centrifugal pump 109.

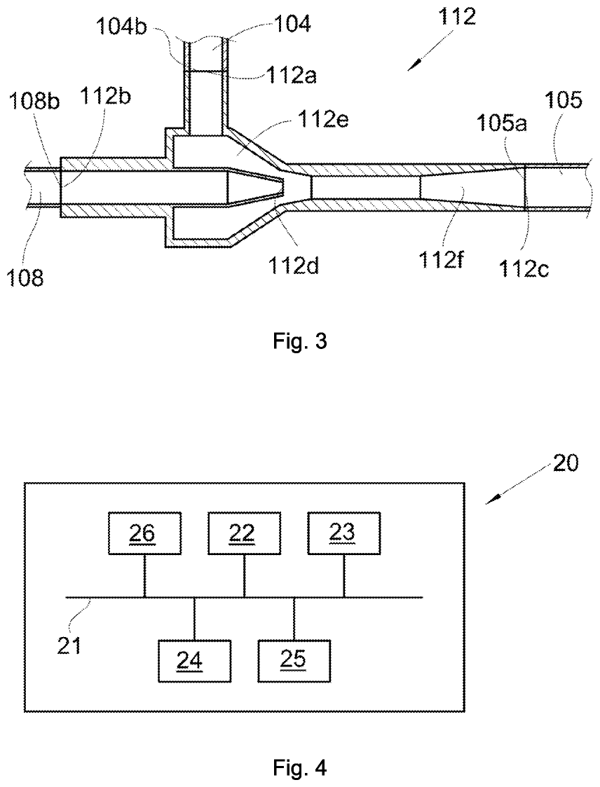

The tank system 100 also comprises a jet pump 112, one embodiment of which is shown in FIG. 3 and which has a low-pressure inlet 112a, a high-pressure inlet 112b and an outlet 112c.

The low-pressure inlet 112a is fluidically connected to the second end 104b of the first feed line 104, the high-pressure inlet 112b is fluidically connected to the second end 108b of the return line 108 and the outlet 112c is fluidically connected to the first end 105a of the second feed line 105.

The jet pump 112 conventionally operates by entrainment of a first fluid, here hydrogen coming from the first end 104a of the first feed line 104, by a second fluid, here hydrogen coming from the return line 108.

The jet pump 112 comprises a mixing chamber 112e into which open the second end 104b of the first feed line 104 and the second end 108b of the return line 108 through a nozzle 112d that creates a low-pressure zone. After mixing, hydrogen is expelled through a diffuser 112f where its speed decreases and pressure increases before reaching the first end 105a of the second feed line 105.

With such an arrangement, the energy contained in the hydrogen flowing through the return line 108 makes the jet pump 112 operate. This ensures an increase in pressure through use of a flow the energy of which would otherwise be lost on exhaustion to the exterior and this allows a better efficiency than the centrifugal pump 109 alone. Furthermore, because of its robustness against two-phase hydrogen flows, the jet pump 112 adds additional robustness to the tank system 100 and widens the operating range in which the centrifugal pump 109 is tolerant to void fraction.

In the embodiment of the invention presented here, the second feed line 105 passes through the wall of the tank 102 at the level of the outlet orifice 102b and the return line 108 passes through the wall of the tank 102 at the level of the inlet orifice 102a.

According to one particular embodiment, the jet pump 112 is placed in the tank 102, i.e., it is submerged in the hydrogen. The return line 108 is therefore also at least partly submerged in the tank 102. Such an arrangement makes it possible to cool the hydrogen flow of the return line 108, this further improving robustness with respect to two-phase flows.

In order to regulate the flow rate in the return line 108, a regulating means 110 is mounted on the return line 108.

The regulating means 110 may for example be a fixed restriction the cross section of flow of which is calibrated to achieve a suitable flow rate in the return line 108 throughout the operating range of the tank system 100, and more particularly of the centrifugal pump 109.

The regulating means 110 may for example be a regulating valve the cross section of flow of which is adjustable so as to control the flow rate in the return line 108. This regulating valve is controlled by a control unit 20 so as to keep the NPSP at the inlet of the centrifugal pump 109 within a range of values appropriate for the operation of the centrifugal pump. According to one particular embodiment, the control unit 20 calculates the NPSP at the inlet of the centrifugal pump 109 from temperature and pressure measurements at the inlet of the centrifugal pump 109. To this end, a temperature sensor and a pressure sensor are placed at the second end 105b of the second feed line 105.

According to one particular embodiment shown in FIG. 4, the control unit 20 comprises, connected by a communication bus 21: a processor 22 or central processing unit (CPU); a random-access memory (RAM) 23; a read-only memory (ROM) 24 or flash memory; a storage unit 25 such as a hard disk or a reader of a storage medium, such as a reader of an SD card (SD standing for Secure Digital); and at least one communication interface 26, for example allowing the control unit 20 to communicate with the valve, pumps, sensors, etc.

The processor is capable of executing instructions loaded into the RAM on turn-on from the ROM or flash, from an external memory (not shown), from a storage medium (such as an SD card), or from a communication network. When the equipment is turned on, the processor is capable of reading instructions from the RAM and of executing them. These instructions form a computer program which causes the processor to implement all or some of the algorithms and steps described above.

All or some of the algorithms and steps described above may be implemented in software form through execution of a set of instructions by a programmable machine, for example a digital signal processor (DSP) or a microcontroller, or be implemented in hardware form by a machine or a dedicated component, for example a field-programmable gate array (FPGA) or application-specific integrated circuit (ASIC).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A tank system for an aircraft, said tank system comprising:
a tank configured to contain hydrogen;
a first feed line having a first end submerged in the tank and a second end;
a second feed line having a first end and a second end;
a third feed line having a first end and a second end configured to be fluidically connected to a consumer system of the aircraft;
a centrifugal pump mounted between the second end of the second feed line and the first end of the third feed line;
a return line having a first end fluidically connected to the third feed line and a second end;
a jet pump having a low-pressure inlet fluidically connected to the second end of the first feed line, a high-pressure inlet fluidically connected to the second end of the return line, and an outlet fluidically connected to the first end of the second feed line;
a control unit; and
a regulating means mounted on the return line, the regulating means comprising a regulating valve of adjustable cross section of flow controlled by the control unit,
wherein the control unit controls the regulating valve of adjustable cross section of flow so as to keep a net positive suction pressure (NPSP) at an inlet of the centrifugal pump within a range of values appropriate for an operation of the centrifugal pump.

2. The tank system according to claim 1, wherein the jet pump is in the tank.

3. The tank system according to claim 1, further comprising:
a temperature sensor and a pressure sensor placed at the second end of the second feed line,
wherein the control unit calculates the NPSP at the inlet of the centrifugal pump from measurements of temperature and pressure at the inlet of the centrifugal pump, the measurements being taken, respectively, by the temperature sensor and the pressure sensor.

4. An aircraft comprising:
a consumer system; and
the tank system according to claim 1, the second end of the third feed line fluidically connected to the consumer system.
